(19) United States
(12) Patent Application Publication
(10) Pub. No.: US 2026/0370498 A1
(43) Pub. Date: Nov. 19, 2026

(54) BLOCK PROPOSAL METHOD AND APPARATUS, ELECTRONIC DEVICE, AND READABLE MEDIUM

(71) Applicant: TENCENT TECHNOLOGY (SHENZHEN) COMPANY LIMITED, Shenzhen (CN)

(72) Inventor: Zhuguang SHAO, Shenzhen (CN)

(73) Assignee: TENCENT TECHNOLOGY (SHENZHEN) COMPANY LIMITED, Shenzhen (CN)

(21) Appl. No.: 19/670,835

(22) Filed: May 7, 2026

Related U.S. Application Data
(63) Continuation of application No. PCT/CN2025/081601, filed on Mar. 10, 2025.

(30) Foreign Application Priority Data
Apr. 8, 2024 (CN) 202410418430.9

(51) Int. Cl. H04L 9/00

(52) U.S. Cl. CPC H04L 9/50

(57) ABSTRACT

A block proposal method, apparatus, and computer-readable storage medium for adaptive blockchain consensus. The method acquires voting results from blockchain nodes for a first block proposal within a first consensus round, each voting result containing suggested transaction quantities determined from the first proposed transaction quantity and execution time. A transaction quantity limit for the next consensus round is generated based on these suggested quantities. Blockchain transactions are packaged from the local transaction pool according to this limit, and a second block proposal is generated and broadcast for voting in the second consensus round. This approach enables dynamic transaction throughput optimization by adjusting block sizes based on actual execution performance feedback from consensus participants.

### CROSS-REFERENCE TO RELATED APPLICATIONS

This application is a continuation application of International Application No. PCT/CN2025/081601 filed on Mar. 10, 2025 which claims priority to Chinese Patent Application No. 202410418430.9, filed with the China National Intellectual Property Administration on Apr. 8, 2024, the disclosures of each being incorporated by reference herein in their entireties.

### FIELD

The disclosure relates to the field of computer technology, blockchain technology, a block proposal method and apparatus, an electronic device, and a readable medium.

### BACKGROUND

With the development of blockchain technology, more and more business systems have started to use blockchain. In blockchain, blockchain nodes package multiple blockchain transactions into a proposal to reach a consensus among the nodes. Only after the consensus is reached, a block is generated in the blockchain.

In the related technologies, the blockchain node packages blockchain transactions into the proposal according to a preset block transaction quantity upper limit and a block execution time upper limit.

However, in such technologies, a proposal process tends to package as many transactions as possible according to the block execution time upper limit, such that the execution time of a proposed block approaches the block execution time upper limit. This may lead to other nodes opposing the consensus due to the fact that the execution time of the other nodes during the verification of the proposal exceeds the block execution time upper limit, thereby causing the proposal to fail and affecting the blockchain operation efficiency.

### SUMMARY

Provided are a block proposal method and apparatus, a device, a storage medium, and a program product, which can implement adaptive blockchain transaction processing through dynamic transaction quantity adjustment based on consensus round execution performance.

According to some embodiments, a block proposal method, performed by blockchain nodes in a blockchain, includes: acquiring a plurality of voting results generated for a first block proposal by a plurality of blockchain nodes within a first consensus round in the blockchain, each of the plurality of voting results comprising a suggested transaction quantity that is determined based on a first proposed transaction quantity in the first block proposal and an execution time for executing the first block proposal; generating a transaction quantity limit for a second consensus round based on the suggested transaction quantity in each of the plurality of voting results, the second consensus round being a next consensus round of the first consensus round; packaging blockchain transactions from a local transaction pool based on the transaction quantity limit; generating a second block proposal for the plurality of blockchain nodes within the second consensus round in the blockchain to vote; and broadcasting the second block proposal in the blockchain.

According to some embodiments, a block proposal apparatus, includes: at least one memory configured to store program code; and at least one processor configured to read the program code and operate as instructed by the program code, the program code including: acquiring code configured to cause at least one of the at least one processor to acquire a plurality of voting results generated for a first block proposal by a plurality of blockchain nodes within a first consensus round in the blockchain, each of the plurality of voting results comprising a suggested transaction quantity that is determined based on a first proposed transaction quantity in the first block proposal and an execution time for executing the first block proposal; generation code configured to cause at least one of the at least one processor to generate a transaction quantity limit for a second consensus round based on the suggested transaction quantity in each of the plurality of voting results, the second consensus round being a next consensus round of the first consensus round; packaging code configured to cause at least one of the at least one processor to package blockchain transactions from a local transaction pool based on the transaction quantity limit; proposal code configured to cause at least one of the at least one processor to generate a second block proposal for the plurality of blockchain nodes within the second consensus round in the blockchain to vote; and broadcasting code configured to cause at least one of the at least one processor to broadcast the second block proposal in the blockchain.

According to some embodiments, a non-transitory computer-readable storage medium, storing computer code which, when executed by at least one processor, causes the at least one processor to at least: acquire a plurality of voting results generated for a first block proposal by a plurality of blockchain nodes within a first consensus round in the blockchain, each of the plurality of voting results comprising a suggested transaction quantity that is determined based on a first proposed transaction quantity in the first block proposal and an execution time for executing the first block proposal; generate a transaction quantity limit for a second consensus round based on the suggested transaction quantity in each of the plurality of voting results, the second consensus round being a next consensus round of the first consensus round; package blockchain transactions from a local transaction pool based on the transaction quantity limit; generate a second block proposal for the plurality of blockchain nodes within the second consensus round in the blockchain to vote; and broadcast the second block proposal in the blockchain.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an exemplary system architecture of a technical solution of this application in an application scenario.

FIG. 2 is a schematic diagram showing the overall situation of a block proposal according to some embodiments.

FIG. 3 is a schematic diagram of a blockchain network according to some embodiments.

FIG. 4 is a schematic diagram of a block in a blockchain network according to some embodiments.

FIG. 5 is a flowchart of a block proposal method according to some embodiments.

FIG. 6 is a flowchart of a block proposal method according to some embodiments.

FIG. 7 is a logic schematic diagram of generating a transaction quantity limit for a second consensus round according to some embodiments.

FIG. 8 is another logic schematic diagram of generating a transaction quantity limit for a second consensus round according to some embodiments.

FIG. 9 is another logic schematic diagram of generating a transaction quantity limit for a second consensus round according to some embodiments.

FIG. 10 is a flowchart of a block proposal method according to some embodiments.

FIG. 11 is a schematic diagram showing node voting results according to some embodiments.

FIG. 12 is a schematic diagram showing the structure of node voting results according to some embodiments.

FIG. 13 is a schematic flowchart of the overall process of block proposal processing according to some embodiments.

FIG. 14 schematically shows a block diagram of the composition of a block proposal apparatus according to some embodiments.

FIG. 15 shows a schematic structural diagram of a computer system of an electronic device applicable to implementing some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The technical solutions in the embodiments of this application are clearly and completely described in the following with reference to the drawing in the embodiments of this application. Apparently, the described embodiments are merely some rather than all of the embodiments of this application. All other embodiments obtained by persons of ordinary skill in the art based on the embodiments of this application without creative efforts shall fall within the scope of protection of this application.

In addition, the described features, structures, or characteristics may be combined in one or more embodiments in any proper manner. In the following descriptions, many details are provided for comprehensive understanding of the embodiments of this application. However, a person of ordinary skill in the art is to be aware that, the technical solutions in this application may be implemented without one or more of the particular details, or may be implemented by using another method, unit, apparatus, operation, or the like. In other cases, well-known methods, apparatuses, implementations, or operations are not shown or described in detail, so as to avoid obscuring various aspects of this application.

In the embodiment of this application, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to realize one or more modules or units. In addition, each module or unit may be a part of an overall module or unit including the module or unit function.

The block diagrams shown in the drawing are merely functional entities and do not necessarily correspond to physically independent entities. To be specific, these functional entities may be implemented in the form of software, or in one or more hardware modules or integrated circuits, or in different networks, processor apparatuses, and microcontroller apparatuses.

The flowcharts shown in the drawing are merely exemplary descriptions, and do not necessarily include all content and operations/blocks, nor do they have to be executed in the described order. For example, some operations/blocks may further be broken down, but some operations/blocks may be merged or partially merged. Therefore, an actual execution order may change according to an actual situation.

The solutions of this application are applied to the process of making a proposal by consensus nodes of a blockchain, and are applied to a scenario in which blockchain transactions are packaged into a proposal. The blockchain system is actually a distributed system, but is different from an ordinary distributed system. In the blockchain system, consensus nodes would run a consensus on a block they agree upon. Only after the consensus is reached, the block would be accepted by the entire blockchain system, i.e., blockchain consensus. One block would generally include many transactions. Generally, within an allowed range, the larger the transaction quantity, the better. This is because, in addition to storing transactions, the block would further store block header information, node voting information and the like. The block header information, node voting information and the like are often basically fixed in size. Therefore, the more the transactions stored in the block, the more space is saved. This allowed range generally includes two parts: a maximum quantity of transactions in one blockchain and the longest execution time of transactions in an entire block.

The block header is a part of each block in a blockchain, and includes information such as input information feature value, version number, timestamp, difficulty value, and a block header feature value of a parent block, and is configured to ensure that block data stored in each block in the blockchain is associated with block data stored in a parent block, thereby ensuring the security of input information in the block.

The blockchain transaction is an operation unit that performs a series of interaction activities such as data transmission, processing, and verification between blockchain nodes in a blockchain system. The blockchain nodes package multiple such transactions into a proposal to reach a consensus among the nodes. After the consensus is reached, a block including these pieces of transaction information is generated in the blockchain. There are limitations such as a quantity upper limit and an execution time upper limit for this operation. Moreover, during the consensus of the blockchain, the blockchain node would make a suggestion to a transaction quantity to be included in a next round of consensus proposal according to the execution status of transactions in the proposal, so as to dynamically adjust the quantity of transactions in each block, thereby improving the blockchain operation efficiency.

Maximum quantity: A quantity upper limit value obtained by calculation according to a suggested transaction quantity in each node vote when determining transactions to be packaged next time. A next-round master node would acquire to-be-packaged transactions from a transaction pool according to the quantity upper limit.

If a transaction quantity in a blockchain is very large and not controlled, since the transactions may be executed, excessively large computing resources of nodes would be consumed, thereby affecting the performance of the entire blockchain. Similarly, if the execution time of a block is not controlled, it would also take a very long time for the entire blockchain to reach a consensus, thereby affecting the performance of the blockchain.

A current common solution in the industry is to set an upper limit for these two parameters, where the quantity upper limit would generally be set according to the transaction volume per second and a business requirement, and the time would often be set to a fixed value, for example, 10 seconds. The transaction volume refers to a quantity of transactions occurring per unit time in a blockchain system, and is generally configured for measuring the processing capability and the business busyness of the blockchain system. The quantity upper limit would generally be set according to the transaction volume per second and a service requirement.

From the perspective of time, there would be certain risks. For higher performance, for a master node of a proposal, the master node would certainly package more transactions into the proposal as much as possible. In this way, the execution time would be relatively long, but certainly would be less than 10 seconds (for example, 9.8 seconds). However, different from the master node, a slave node would also execute all transactions in this block. Once the execution time exceeds 10 seconds due to the impact of factors such as server performance and the occupancy of resources, the slave node would consider that the proposal from the master node has a problem, and cast a negative vote. This may subsequently lead to the need for running a new consensus due to disagreement upon this round of consensus, thereby affecting the overall performance of the blockchain.

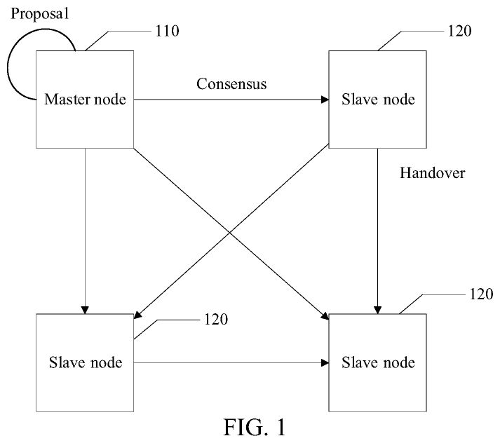

Based on this, the technical solution of some embodiments proposes a block proposal method. Specifically, as shown in FIG. 1, a system architecture applied to the block proposal method according to some embodiments may include a blockchain network including four blockchain nodes. An electronic device for implementing a blockchain node may be a smartphone, a tablet computer, a notebook computer, an intelligent voice interaction device, a smart home appliance, a vehicle-mounted terminal, an aircraft, and so on. The electronic device for implementing the blockchain node may also be a server that provides various services. The electronic device may be an independent physical server, or may be a server cluster or distributed system including a plurality of physical servers, or may be a cloud server that provides cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. Between blockchain nodes, there may be various connection types of communications media for a communications link, for example, a wired communications link or a wireless communication link.

Depending on some embodiments requirement, the system architecture in some embodiments may have any number of terminal devices and servers. For example, the electronic device implementing the blockchain node may be a server group including a plurality of server devices. In addition, the technical solution provided in some embodiments may be applied to any blockchain node, or may be jointly implemented by a plurality of blockchain nodes, which will not be limited in this application.

As shown in FIG. 1, one blockchain node, as a master node 110 in a blockchain, makes a proposal. The master node may be any consensus node in the blockchain, and the consensus nodes in the blockchain would generally take turns acting as a master node according to a predetermined rule to make proposals. Other consensus nodes other than the master node become slave nodes. The slave nodes vote according to the proposal from the master node to reach a consensus. After determining that the consensus is reached, the master node notifies each slave node to upload a new block. In some embodiments, the master node 110 in the blockchain would send a block proposal to slave nodes 120. When the slave nodes send votes on the block proposal to the master node 110, the slave nodes 120 would also each provide a suggested quantity about the quantity of transactions to be packaged in a next-round proposal. All the slave nodes 120 would vote and provide a suggested quantity. The master node 110 would determine, according to the suggestion provided by each slave node 120, the quantity of transactions to be packaged in a next round. Moreover, packaging is performed according to the determined quantity in the next-round proposal.

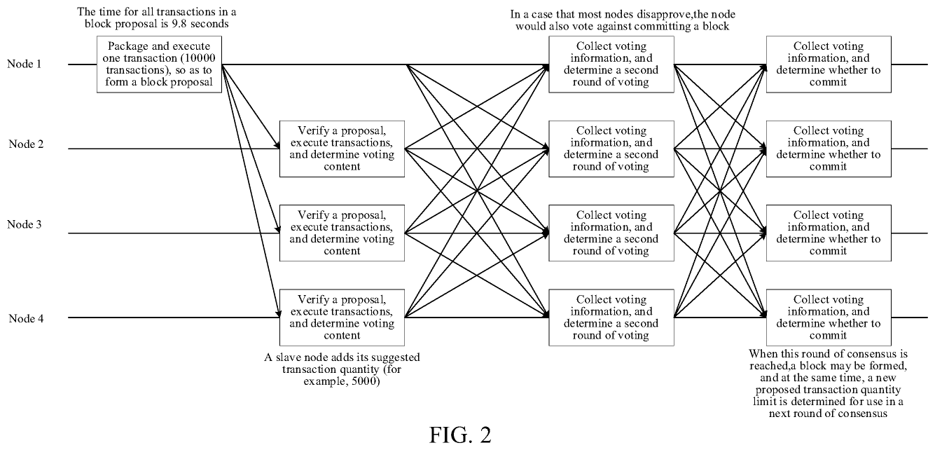

Referring to FIG. 2, FIG. 2 is a schematic diagram showing the overall situation of a block proposal according to some embodiments. As shown in FIG. 2, a master node would package and execute one transaction (10000 transactions) to form a block proposal. It is assumed that the time for the master node to execute all transactions in the block proposal is 9.8 seconds. The block proposal would be broadcast to slave nodes in a blockchain. Node 2, node 3, and node 4 would verify a received proposal. Each node would execute all transactions in the received block proposal, and determine, based on an execution result, voting content, for example, voting in favor of or voting against a block depending on whether all transactions are executed successfully. At the same time, the nodes would further collect statistics on the execution time to execute all the transactions in the proposal and execution timeout. It is assumed that the total execution time of a slave node is 10.2 seconds, due to transaction timeout, the voting content of the node would indicate negative votes. The node would further generate its suggested transaction quantity according to the execution time and the transaction quantity included in the proposal. For example, due to execution timeout, the slave node would suggest setting the transaction quantity to 5000, and the slave node would add its suggested transaction quantity to the voting information for the proposal. The voting information of the slave node would be broadcast to other nodes. All nodes in the blockchain would collect the voting information from the other nodes about the proposal, and determine, according to the collected voting information, whether to approve uploading the block in a second round of voting. In the second round of voting, if most nodes do not approve uploading the block, each node would also vote against committing the block. Subsequently, each node would collect the voting information from the other nodes for the second round of voting, thereby determining whether to commit the block finally. At the same time, a new proposed transaction quantity limit would also be determined according to the transaction quantity suggested by each slave node. In a next round of consensus, a node that becomes the master node would package transactions into a proposal according to a proposed transaction quantity limit determined by the node. For example, most nodes suggest setting the transaction quantity to 5000, then in a next-round proposal, the master node would package 5000 transactions into a proposal for the proposal process. If most blocks still time out when executing a proposal with 5000 transactions, then through the foregoing processes of voting and redetermining the transaction quantity, the transaction quantity in the proposal would be further reduced. If most nodes have spare processing capability when executing 5000 transactions, the transaction quantity may be increased through the foregoing processes.

Blockchain is a new application mode of computer technologies such as distributed data storage, point-to-point transmission, a consensus mechanism, and an encryption algorithm. The blockchain is essentially a decentralized database, which is a string of data blocks (i.e., blocks) generated in association with each other in a cryptographic manner. Each data block includes information about a batch of network transactions. The information is configured for verifying the validity (authenticity) of the information of each data block and generating a next block. The blockchain is maintained jointly by nodes in a blockchain network. For example, the blockchain network shown in FIG. 3 may include a plurality of nodes 301, and the plurality of nodes 301 may be individual clients that form the blockchain network. During normal operation, each node 301 may receive input information, and maintain, based on the received input information, shared data within the blockchain network. To ensure information exchange within the blockchain network, there may be an information connection between the nodes in the blockchain network. Information may be transmitted between the nodes through the above-mentioned information connection. For example, when any node in the blockchain network receives input information, other nodes in the blockchain network acquire the input information according to a consensus algorithm, and store the input information as shared data, such that data stored on all nodes in the blockchain network is consistent. The consensus algorithm is an algorithm through which a plurality of nodes in a blockchain network reach a consensus on a block proposal. Using the algorithm, the node may acquire input information and store the input information as shared data, such that data stored on all nodes in the blockchain network is consistent.

Each node in the blockchain network has a corresponding node identifier, and each node in the blockchain network may store node identifiers of other nodes, so as to subsequently broadcast a generated block to the other nodes in the blockchain network according to the node identifiers of the other nodes. A node identifier list may be maintained by each node, and a node name and a node identifier are correspondingly stored in the node identifier list. The node identifier may be an Internet protocol (IP, a protocol for interconnection between networks) address and any other information that can be configured for identifying the node.

Node identifier list: a list maintained by each node in a blockchain network, which is configured for correspondingly storing a node name and a node identifier. The node identifier may be an Internet protocol (IP, a protocol for interconnection between networks) address and any other information that can be configured for identifying the node, such that the node subsequently broadcasts a generated block to other nodes in the blockchain network according to the node identifiers of the other nodes.

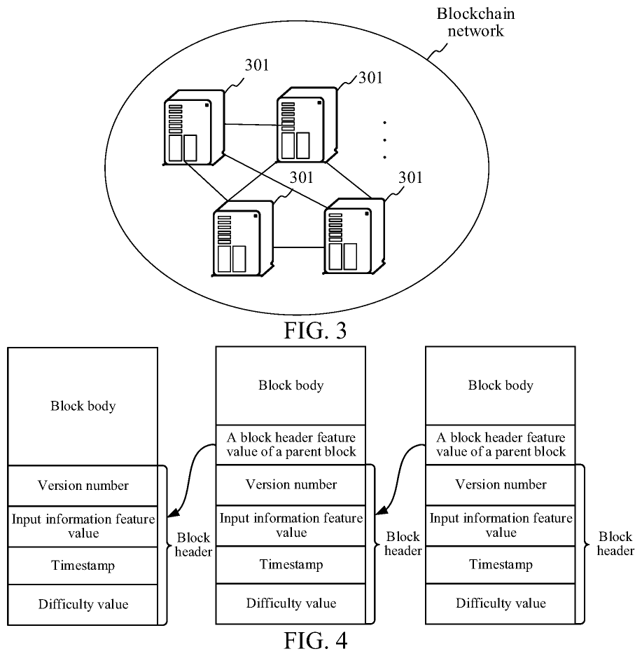

Each node in a blockchain network stores a same blockchain. The blockchain includes a plurality of blocks. Referring to FIG. 4, the blockchain includes a plurality of blocks, and a genesis block includes a block header and a block body, where the block header stores an input information feature value, a version number, a timestamp, a difficulty value, and the like, and the block body stores input information. A next block of the genesis block takes the genesis block as a parent block, and also includes a block header and a block body, where the block header stores an input information feature value of a current block, a block header feature value of the parent block, a version number, a timestamp, a difficulty value, and the like, and so on, such that block data stored in each block in the blockchain is associated with block data stored in the parent block, thereby ensuring the security of the input information within the blocks.

The genesis block is a first block in a blockchain, and includes a block header and a block body, where the block header stores an input information feature value, a version number, a timestamp, a difficulty value, and the like, and the block body stores input information. The genesis block is a foundation for subsequent blocks. The subsequent blocks are sequentially generated by taking the genesis block as a parent block.

Parent block: In a blockchain, each block has a previous block, and the previous block is a parent block of a current block. The block header of each block would store a block header feature value of the parent block, so that block data stored in each block in the blockchain is associated with block data stored in the parent block of the block, thereby ensuring the security of input information in the blocks.

Blockchain data obtained by the master node 110 and the slave nodes 120 may be of a block structure as shown in FIG. 4. Although three blocks are shown, the master node 110 and the slave nodes 120 may obtain more or fewer blocks at one time, or obtain all blocks in a blockchain at one time.

In some embodiments, information related to a suggested transaction quantity may be saved in the block body of the blockchain structure shown in FIG. 4 in the form of blockchain transactions, and undergoes a consensus among nodes along with a block and is uploaded in the blockchain.

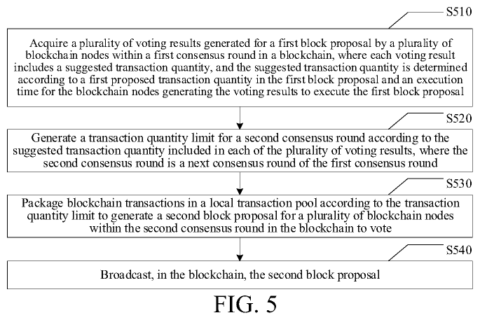

FIG. 5 is a flowchart of a block proposal method according to some embodiments. The block proposal method may be executed by a device having a computing processing function. For example, the device may be a computing device of a blockchain node. Referring to FIG. 5, the block proposal method includes at least operation S510 to operation S540, which will be introduced in detail below.

Operation S510. Acquire a plurality of voting results generated for a first block proposal by a plurality of blockchain nodes within a first consensus round in a blockchain, where each voting result includes a suggested transaction quantity, and the suggested transaction quantity is determined according to a first proposed transaction quantity in the first block proposal and an execution time for the blockchain nodes generating the voting results to execute the first block proposal.

The first consensus round is a round of voting and reaching a consensus on a first block proposal in the consensus process of a blockchain. When executing operation S510, the first consensus round is a current consensus round.

The second consensus round is a next consensus round of the first consensus round. In this round, the master node would package blockchain transactions according to a transaction quantity limit for the second consensus round determined in the previous round, so as to make a proposal.

The first block proposal is a block proposal generated by a master node packaging blockchain transactions in a current consensus round (the first consensus round). The first block proposal is configured for consensus among blockchain nodes.

In a blockchain scenario, the transaction is an operation unit that performs a series of interaction activities such as data transmission, processing, and verification between blockchain nodes in a blockchain system. The blockchain nodes package multiple such transactions into a proposal to reach a consensus among the nodes. After the consensus is reached, a block including these pieces of transaction information is generated in the blockchain.

The suggested transaction quantity is a quantity value determined according to a first proposed transaction quantity in a first block proposal and an execution time for the blockchain nodes generating the voting results to execute the first block proposal. The quantity value represents a suggestion made by a voting node regarding the transaction quantity to be included in a next round of consensus proposal according to the execution of the first block proposal by the voting node.

The first proposed transaction quantity refers to a transaction quantity used when packaging a first block proposal.

A current blockchain node (i.e., a blockchain node that currently executes the block proposal method) is a slave node in the first consensus round, which would receive, from each node in the blockchain, a plurality of voting results generated for the first block proposal by a plurality of blockchain nodes within the first consensus round of the first block proposal. The first block proposal is a block packaged and generated by a master node in the current consensus round. A transaction quantity limit used when packaging the first block proposal may also be determined according to the solution of this application. The voting result is determined, based on a check and execution result of the first block proposal, by each node in the blockchain, and voting content (typically in favor or against, and a suggested transaction quantity) of the node for the first block proposal would be included in the voting result. The suggested transaction quantity is determined according to a first proposed transaction quantity in a first block proposal and an execution time for the blockchain nodes generating the voting results to execute the first block proposal. The quantity value represents a suggestion made by a voting node regarding the transaction quantity to be included in a next round of consensus proposal according to the execution of the first block proposal by the voting node. If a voting node finds that the execution of the first block proposal has timed out, the determined suggested transaction quantity would be less than the first proposed transaction quantity, while if the voting node finds that the execution time is still relatively far from a preset maximum time after executing the first block proposal, a suggested transaction quantity more than the first proposed transaction quantity would be proposed. It is to be emphasized that the plurality of voting results generated for the first block proposal by the plurality of blockchain nodes within the first consensus round and obtained by a local node are not necessarily from all nodes in the blockchain, as long as the quantity of obtained votes meets the condition for determining a consensus result in a consensus policy of the blockchain. To be specific, if the consensus condition requires that the consensus is reached upon approval from half of the nodes, the local node can determine a consensus result upon receiving either half of positive votes or half of negative votes, and executes the solution of this application. A plurality of in this application may be at least two.

Operation S520. Generate a transaction quantity limit for a second consensus round according to the suggested transaction quantity included in each of the plurality of voting results, where the second consensus round is a next consensus round of the first consensus round.

The transaction quantity limit is a limit value of a transaction quantity used by a master node in a consensus round when proposing. The value is generated by a suggested transaction quantity in each of voting results generated for a previous block proposal by a plurality of blockchain nodes in a previous round of consensus.

The local node would generate a transaction quantity limit for a second consensus round according to a suggested transaction quantity in each of the plurality of voting results generated for the first block proposal by a plurality of blockchain nodes within the first consensus round. The second consensus round is a next consensus round of the first consensus round. The transaction quantity limit for the second consensus round would be used as a transaction quantity limit when the master node in the next consensus round makes a proposal. When determining the transaction quantity limit for the second consensus round, some of the suggested transaction quantities may be first selected, according to a preset generation policy, from the plurality of voting results generated for the first block proposal by the plurality of blockchain nodes within the first consensus round. For example, when the execution time is shorter than a preset time, a suggested transaction quantity greater than the first proposed transaction quantity is selected, and when execution times out, a suggested transaction quantity less than the first proposed transaction quantity is selected. The transaction quantity limit for the second consensus round is then determined based on the selected suggested transaction quantity. For example, the transaction quantity limit may be selected from one of a mean value, a maximum value, and a median value.

Operation S530. Package blockchain transactions in a local transaction pool according to the transaction quantity limit to generate a second block proposal for a plurality of blockchain nodes within the second consensus round in the blockchain to vote.

The local transaction pool is a collection of blockchain transactions locally stored by a blockchain node. The master node would acquire the transactions from the pool and package the transactions to generate a block proposal.

In some embodiments, the local node becomes the master node in a next consensus round. After becoming the master node, the local node would determine, according to a voting result in a previous round, whether to package and upload the transactions according to the first block proposal, regardless of whether the consensus is reached on the first block proposal. In the next round of consensus, when a proposal may be made, the master node would use the transaction quantity limit for the second consensus round determined in the previous round of consensus as a transaction quantity limit at the time of proposal. To be specific, the local node would package blockchain transactions up to the transaction quantity limit in the local transaction pool to generate a second block proposal for a plurality of blockchain nodes within the second consensus round in the blockchain to vote; and broadcasts, in the blockchain, the second block proposal. Depending on whether the consensus result of the first block proposal succeeds, a transaction included in the second block proposal may be the same as or different from that of the first block proposal. Specifically, when packaging the second block proposal, the local node would execute a to-be-packaged transaction and collect statistics on the execution time. The local node would ensure that the transaction quantity in the second block proposal is less than or equal to the transaction quantity limit and the total execution time of all transactions in the second block proposal does not exceed a preset execution time threshold in the blockchain.

Total execution time: The total time taken by a blockchain node to execute all blockchain transactions in a block proposal, where the node would generate a suggested quantity of transactions according to the time and a number of completed transactions. The suggested quantity of transactions has the same meaning as the suggested transaction quantity, which refers to a quantity value generated by a node according to a total execution time to execute all transactions in a block proposal and a number of completed transactions. The quantity value represents a suggestion made by a node regarding a transaction quantity to be included in a next round of consensus proposal according to the execution of the block proposal by the node, and would be added to a voting result.

Operation S540. Broadcast, in the blockchain, the second block proposal.

The second block proposal is a block proposal generated by the master node packaging the blockchain transactions in the local transaction pool in a next consensus round (the second consensus round) according to the transaction quantity limit for the second consensus round, and the second block proposal is configured for instructing a plurality of blockchain nodes in the second consensus round in the blockchain to vote.

After packaging is completed, the local node, as a master node in a current consensus round (which becomes a previous round of consensus after the first block proposal is completed), would broadcast, in the blockchain, the second block proposal. The slave nodes in the blockchain then run a consensus process according to the second block proposal, and after reaching the consensus, generate, in the blockchain, a block committed by the second block proposal. In the consensus process of the second block proposal, each slave node would also make a suggestion on a transaction quantity based on the transaction quantity and the execution time of the second block proposal, thereby further adjusting the quantity of transactions to be packaged in a block proposal of a next consensus round. Therefore, the transaction quantity limit in the block proposal would be dynamically adjusted according to the suggested transaction quantity provided by each slave node in the consensus process. This can solve the problems of timeout caused by excessive transactions or resource waste caused by too few transactions in a timely manner, and manual intervention and configuration are not required, such that the blockchain operation efficiency is higher.

In some embodiments, the blockchain node would acquire a plurality of voting results generated for a first block proposal by a plurality of blockchain nodes within a first consensus round of the first block proposal, and then generate a transaction quantity limit for a second consensus round according to a suggested transaction quantity in each voting result, where the second consensus round is a next consensus round of the first consensus round. Moreover, when becoming a proposal node, the blockchain node packages blockchain transactions according to the determined transaction quantity limit for the second consensus round into a new block proposal, and broadcasts, in the blockchain, the new block proposal, so as to generate a new block in the blockchain. In this way, the quantity of transactions to be packaged when a proposal is made next time is adjusted according to the suggestion from each node in the consensus process, such that the transactions included in the block proposal can be automatically adjusted according to the execution result and the execution time of the proposal, thus avoiding execution timeout during proposal verification caused by excessive transactions in the block, further preventing a proposal failure due to timeout during proposal verification, and facilitating the improvement of the blockchain operation efficiency.

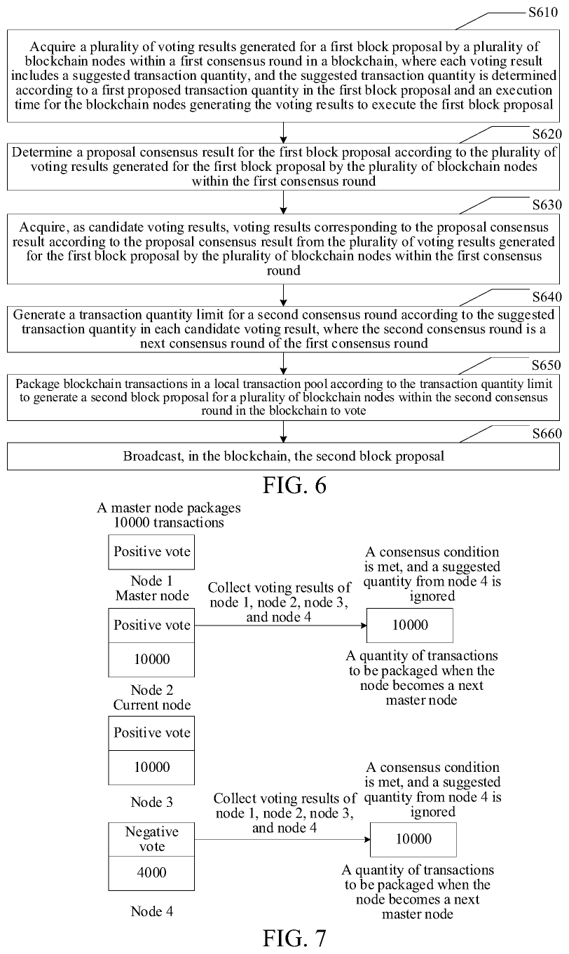

In some embodiments, other embodiments that refine the technical solution of the embodiment shown in FIG. 5 are also provided, as shown in FIG. 6. The block proposal method of some embodiments may include the following operations.

Operation S610. Acquire a plurality of voting results generated for a first block proposal by a plurality of blockchain nodes within a first consensus round in a blockchain, where each voting result includes a suggested transaction quantity, and the suggested transaction quantity is determined according to a first proposed transaction quantity in the first block proposal and an execution time for the blockchain nodes generating the voting results to execute the first block proposal.

In some embodiments, the implementation details of operation S610 are consistent with those of operation S510 shown in FIG. 5. Details are not described again.

Operation S620. Determine a proposal consensus result for the first block proposal according to the plurality of voting results generated for the first block proposal by the plurality of blockchain nodes within the first consensus round.

The proposal consensus result is a result, regarding whether the consensus is reached on a first block proposal, obtained after a plurality of voting results generated for the first block proposal by a plurality of blockchain nodes within a first consensus round is determined according to a consensus policy of the blockchain. The result is generally divided into proposal success and proposal failure.

Operation S630. Acquire, as candidate voting results, voting results corresponding to the proposal consensus result according to the proposal consensus result from the plurality of voting results generated for the first block proposal by the plurality of blockchain nodes within the first consensus round.

The candidate voting result is a voting result corresponding to the proposal consensus result that is acquired according to a proposal consensus result from the plurality of voting results generated for the first block proposal by the plurality of blockchain nodes within the first consensus round. The voting result is configured for generating a transaction quantity limit for the second consensus round.

Operation S640. Generate a transaction quantity limit for a second consensus round according to the suggested transaction quantity in each candidate voting result, where the second consensus round is a next consensus round of the first consensus round.

In some embodiments, when generating the transaction quantity limit for the second consensus round, the local node would acquire, according to the proposal consensus result, a voting result corresponding to the proposal consensus result from a plurality of voting results generated for the first block proposal by a plurality of blockchain nodes within the first consensus round. Specifically, the local node would first determine a proposal consensus result for the first block proposal according to the plurality of voting results generated for the first block proposal by the plurality of blockchain nodes within the first consensus round. The determining process would be generally determined according to the consensus policy of the blockchain.

For example, in a 3f+1 consensus network, for each round of voting, each node only may collect 2f+1 voting results to determine that the consensus succeeds, or collect f+1 voting results to determine that the consensus fails. However, the voting results collected by the nodes may be different. Consensus network: A network including a plurality of blockchain nodes. Nodes vote on a block proposal in the network and reach a consensus. Different consensus networks have different consensus policies. For example, in a 3f+1 consensus network, for each round of voting, each node only may collect 2f+1 voting results to determine that the consensus succeeds, or collect f+1 voting results to determine that the consensus fails.

The local node would determine the proposal consensus result, and then acquire, as candidate voting results, voting results corresponding to the proposal consensus result according to the proposal consensus result from the plurality of voting results generated for the first block proposal by the plurality of blockchain nodes within the first consensus round. Specifically, the plurality of voting results generated for the first block proposal by a plurality of blockchain nodes within the first consensus round have different degrees of impact and effects on the proposal consensus result, while the local node selects, based on the degree of impact, the degree of association, and the effects of the voting results on the proposal consensus result, a voting result. Generally, the local node would select, as the candidate voting results, voting results that have a positive effect on the proposal consensus result. The effect of the voting result is generally divided into a positive effect, a negative effect, and no effect. The positive effect indicates that the voting result is consistent with the consensus result. The negative effect indicates that the voting result is opposite the consensus result. The no effect indicates that the voting result is not associated with the consensus result. In a case that the consensus result indicates a failure, negative votes have a positive effect, positive votes have a negative effect, and abstention votes have no effect. For example, if the consensus result indicates a failure, but the reason for the failure lies in that a consensus node activates a one-vote veto mechanism, the veto has the most significant impact and effect on the consensus result, and the voting results are acquired as the candidate voting results. In some embodiments, the local node would select, as candidate voting results, some voting results from the voting results that have the positive effect and the voting results that have the negative effect. Finally, the local node would generate a transaction quantity limit for a second consensus round according to the suggested transaction quantity in each candidate voting result, where the second consensus round is a next consensus round of the first consensus round. A transaction quantity limit for a second consensus round is generated according to the suggested transaction quantity in the voting result corresponding to the proposal consensus result, where the second consensus round is a next consensus round of the first consensus round, such that the degree of impact of correct voting results among determining factors for the transaction quantity limit for the second consensus round is higher, thereby facilitating the improvement to the accuracy of the determined transaction quantity limit for the second consensus round.

Operation S650. Package blockchain transactions in a local transaction pool according to the transaction quantity limit to generate a second block proposal for a plurality of blockchain nodes within the second consensus round in the blockchain to vote.

In some embodiments, the implementation details of operation S650 are consistent with those of operation S530 shown in FIG. 5. Details are not described again.

Operation S660. Broadcast, in the blockchain, the second block proposal.

In some embodiments, the implementation details of operation S660 are consistent with those of operation S540 shown in FIG. 5. Details are not described again.

In some embodiments, the blockchain node would acquire a plurality of voting results generated for a first block proposal by a plurality of blockchain nodes within a first consensus round of the first block proposal, and then generate a transaction quantity limit for a second consensus round according to a suggested transaction quantity in each voting result. Moreover, when becoming a proposal node, the blockchain node packages blockchain transactions according to the determined transaction quantity limit for the second consensus round into a new block proposal, and broadcasts, in the blockchain, the new block proposal, so as to generate a new block in the blockchain. In this way, the quantity of transactions to be packaged when a proposal is made next time is adjusted according to the suggestion from each node in the consensus process, such that the transactions included in the block proposal can be automatically adjusted according to the execution result and the execution time of the proposal, thus avoiding execution timeout during proposal verification caused by excessive transactions in the block, further preventing a proposal failure due to timeout during proposal verification, and facilitating the improvement of the blockchain operation efficiency.

In some exemplary embodiments of this application, based on the foregoing technical solutions, in the process of acquiring, as candidate voting results, voting results corresponding to the proposal consensus result according to the proposal consensus result from the plurality of voting results generated for the first block proposal by the plurality of blockchain nodes within the first consensus round, the node uses, as the candidate voting results, if the proposal consensus result indicates that the proposal succeeds, voting results indicating positive votes among the plurality of voting results generated for the first block proposal by the plurality of blockchain nodes within the first consensus round. The node uses, as the candidate voting results, if the proposal consensus result indicates that the proposal fails, voting results indicating negative votes among the plurality of voting results generated for the first block proposal by the plurality of blockchain nodes within the first consensus round. In some embodiments, the local node would select, as candidate voting results, voting results with voting content meeting the proposal consensus result, thus avoiding that the impact of the suggested quantity provided by nodes that misjudge consensus nodes on the determined specified quantity, facilitating the reduction of a probability that the process of determining a transaction quantity is affected by malicious data, and enhancing the security of the blockchain system.

In some exemplary embodiments of this application, based on the foregoing technical solutions, in the process of generating a transaction quantity limit for a second consensus round according to the suggested transaction quantity in each candidate voting result, a first proposed transaction quantity in the first block proposal is acquired if the proposal consensus result indicates that a proposal succeeds. The node uses the first proposed transaction quantity as the transaction quantity limit for the second consensus round if the first proposed transaction quantity is greater than or equal to the suggested transaction quantity in each candidate voting result. The node generates the transaction quantity limit for the second consensus round according to a mean value of the first proposed transaction quantity and the selected suggested transaction quantity if the first proposed transaction quantity is less than the suggested transaction quantity in each candidate voting result.

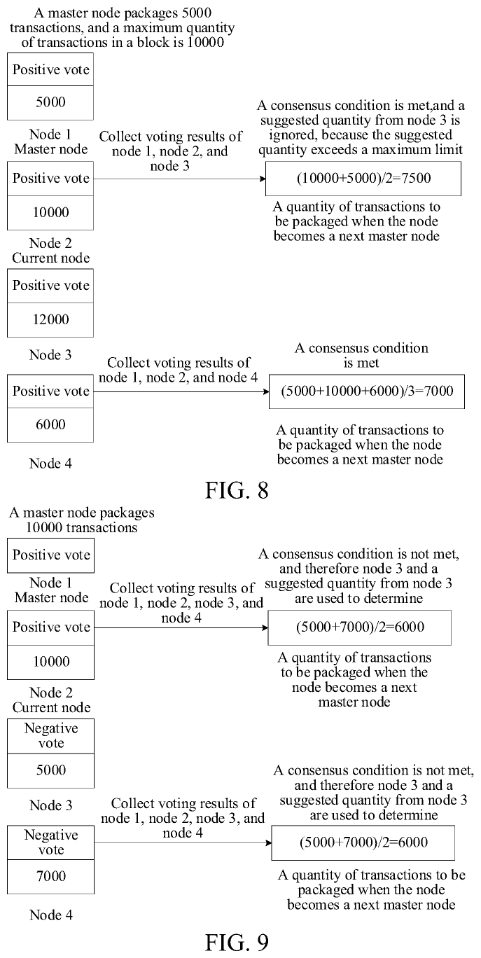

Specifically, when the consensus result indicates that the proposal consensus succeeds, there are two cases: the slave node approves or disapproves the first proposed transaction quantity of transactions packaged by the master node in the first block proposal. Specifically, if the first proposed transaction quantity is greater than or equal to the suggested transaction quantity in each candidate voting result, the slave node approves the quantity of transactions packaged by the master node, and the first proposed transaction quantity may be directly used as the transaction quantity limit for the second consensus round. Referring to FIG. 7, FIG. 7 is a logic schematic diagram of generating a transaction quantity limit for a second consensus round according to some embodiments. As shown in FIG. 7, the suggested transaction quantity provided by node 2 is consistent with the quantity of transactions packaged by the master node. Therefore, if node 2 becomes the master node in a next round, the quantity of transactions packaged by the master node is directly used as the quantity of transactions to be packaged in a next round of consensus. Since node 4 has cast a negative vote, there is no may consider the suggested transaction quantity provided by node 4. If node 4 becomes the master node in a next round, the quantity (i.e., 10000) of transactions packaged by the master node would also be directly used as a quantity to be packaged in a next round of consensus. If the first proposed transaction quantity is less than the suggested transaction quantity in each candidate voting result, the slave node disapproves the quantity of transactions packaged by the master node, and the node may generate the transaction quantity limit for the second consensus round according to a mean value of the first proposed transaction quantity and the selected suggested transaction quantity. Referring to FIG. 8, FIG. 8 is another logic schematic diagram of generating a transaction quantity limit for a second consensus round according to some embodiments. As shown in FIG. 8, the suggested transaction quantity provided by node 2 is 10000, and the master node packages only 5000 transactions. At this point, node 2 disapproves the quantity of transactions packaged by the master node, and when becoming the master node, node 2 would determine the transaction quantity limit for the second consensus round according to a mean value of the suggested transaction quantity and the quantity of the packaged transactions, i.e., 7500. Similarly, the suggested transaction quantity provided by node 4 is 6000, which is also higher than the quantity of transactions packaged by the master node. Therefore, when node 4 becomes the master node, the quantity of transactions to be packaged in the proposal would be 7000. Herein, voting results received by node 2 and node 4 are different. Since node 2 has not received a voting result of node 4, when node 2 determines a transaction quantity limit for the second consensus round, only quantities provided by node 1 and node 2 are considered, and due to exceeding the limit, the quantity provided by node 3 is discarded. In some embodiments, the transaction quantity limit for the second consensus round is correspondingly determined according to the comparison result between the suggested transaction quantity of the slave node and the quantity of transactions packaged by the master node, such that a transaction quantity limit for a block proposal can be increased in a timely manner when the master node packages a relatively small quantity of transactions, thus avoiding the waste of processing resources in the consensus process due to too few transactions in a block, and facilitating the improvement of the resource utilization of the solution.

In some exemplary embodiments of this application, based on the foregoing technical solutions, the candidate voting result includes the plurality of voting results generated for the first block proposal by the plurality of blockchain nodes within the first consensus round. In the process of generating the transaction quantity limit for the second consensus round according to a mean value of the first proposed transaction quantity and the selected suggested transaction quantity if the first proposed transaction quantity is less than the suggested transaction quantity in each candidate voting result, the node acquires a block transaction quantity threshold of the blockchain if the first proposed transaction quantity is less than the suggested transaction quantity in each candidate voting result. The voting results from the candidate voting results are deleted if the suggested transaction quantity in any voting result among the candidate voting results is greater than the block transaction quantity threshold. The node then generates the transaction quantity limit for the second consensus round according to the mean value of the first proposed transaction quantity and the suggested transaction quantity in each voting result among the candidate voting results. In a solution of this application, the suggested transaction quantity would be discarded if the suggested transaction quantity determined by the slave node is greater than a maximum quantity limit in blockchain configuration, thus avoiding a consensus failure caused by proposal execution timeout due to excessive transactions in the block proposal, and facilitating the improvement of the stability of the solution. The block transaction quantity threshold is a maximum quantity limit in blockchain configuration, and is configured for limiting the quantity of transactions in a block proposal. The suggested transaction quantity would be discarded if a suggested transaction quantity determined by a slave node is greater than the threshold.

In some exemplary embodiments of this application, based on the foregoing technical solutions, in the process of generating a transaction quantity limit for a second consensus round according to the suggested transaction quantity in each candidate voting result, the node acquires the suggested transaction quantity in each candidate voting result if a proposal consensus result indicates that a proposal fails, and then determines a transaction quantity limit for the second consensus round according to a sum of the suggested transaction quantities in the candidate voting results and the quantity of the candidate voting results. In some embodiments, if a proposal consensus fails, only the suggested transaction quantity in a voting result indicating negative votes would be selected to determine the transaction quantity limit for the second consensus round.

Referring to FIG. 9, FIG. 9 is another logic schematic diagram of generating a transaction quantity limit for a second consensus round according to some embodiments. As shown in FIG. 9, since the consensus result indicates a failure, the local node would select, as candidate voting results, only the voting results of node 3 and node 4 that include negative votes, and the determined transaction quantity limit for the second consensus round is also a mean value of suggested quantities from node 3 and node 4. The transaction quantity limit for the second consensus round may be determined in other ways, for example, maximum value or minimum value, or clustering is first performed based on the suggested transaction quantity and then classification calculation is performed. When a proposal fails, the transaction quantity limit for the second consensus round is determined according to only the suggested transaction quantity in a candidate voting result indicating a failure, such that an excessively large transaction quantity or an excessively long execution time can be shortened in a timely manner, thus avoiding that a subsequent consensus process fails again, and improving the consensus success rate.

Clustering: A data processing method in which, when determining a transaction quantity limit for a second consensus round, if a proposal consensus fails, data may be first grouped based on a suggested transaction quantity, such that the data in the same group has relatively high similarity, and the data in different groups has relatively great differences, and then classification calculation is performed on the different groups, so as to determine a limit.

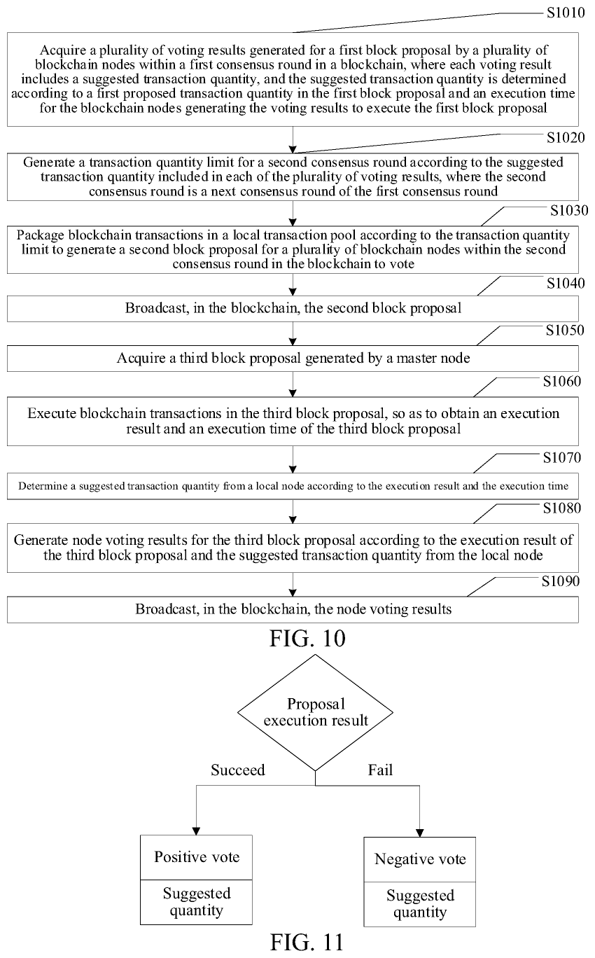

In some embodiments, other embodiments that refine the technical solution of the embodiment shown in FIG. 5 are also provided, as shown in FIG. 10. The block proposal method of some embodiments may include the following operations.

Operation S1010. Acquire a plurality of voting results generated for a first block proposal by a plurality of blockchain nodes within a first consensus round in a blockchain, where each voting result includes a suggested transaction quantity, and the suggested transaction quantity is determined according to a first proposed transaction quantity in the first block proposal and an execution time for the blockchain nodes generating the voting results to execute the first block proposal.

In some embodiments, the implementation details of operation S1010 are consistent with those of operation S510 shown in FIG. 5. Details are not described again.

Operation S1020. Generate a transaction quantity limit for a second consensus round according to the suggested transaction quantity included in each of the plurality of voting results, where the second consensus round is a next consensus round of the first consensus round.

In some embodiments, the implementation details of operation S1020 are consistent with those of operation S520 shown in FIG. 5. Details are not described again.

Operation S1030. Package blockchain transactions in a local transaction pool according to the transaction quantity limit to generate a second block proposal for a plurality of blockchain nodes within the second consensus round in the blockchain to vote.

In some embodiments, the implementation details of operation S1030 are consistent with those of operation S530 shown in FIG. 5. Details are not described again.

Operation S1040. Broadcast, in the blockchain, the second block proposal.

In some embodiments, the implementation details of operation S1040 are consistent with those of operation S540 shown in FIG. 5. Details are not described again.

Operation S1050. Acquire a third block proposal generated by a master node.

The third block proposal is a block proposal generated by packaging by the master node after the second block proposal, but is not necessarily a next-round proposal after the second block proposal.

Operation S1060. Execute blockchain transactions in the third block proposal, so as to obtain an execution result and execution time of the third block proposal.

Operation S1070. Determine a suggested transaction quantity from a local node according to the execution result and the execution time.

Operation S1080. Generate node voting results for the third block proposal according to the execution result of the third block proposal and the suggested transaction quantity from the local node.

The node voting result is a result generated by a local node according to an execution result of a third block proposal and a suggested transaction quantity from the local node. The result includes content such as voting information, voting signature, suggested transaction quantity, current block height, consensus round number, and information signature, and is broadcast in the blockchain to participate in a consensus on the third block proposal.

Operation S1090. Broadcast, in the blockchain, the node voting results.

In some embodiments, after the local node broadcasts the second block proposal, the identity of the local node switches from the master node to a slave node, and another node becomes the master node. The master node would perform packaging to generate a third block proposal. The third block proposal is a proposal after the second block proposal, but is not necessarily a next-round proposal after the second block proposal. As a slave node, the local node would execute blockchain transactions in the third block proposal, so as to obtain an execution result and execution time of the third block proposal. Subsequently, a suggested transaction quantity from the local node is determined according to the execution result and the execution time. Specifically, if the execution result indicates a success, but the execution time is relatively short, the suggested transaction quantity may be increased. If the execution result indicates a failure or a relatively long execution time, the suggested transaction quantity may be decreased. Subsequently, the local nodes generate node voting results for the third block proposal according to the execution result of the third block proposal and the suggested transaction quantity from the local node. Referring to FIG. 11, FIG. 11 is a schematic diagram showing node voting results according to some embodiments. As shown in FIG. 11, the node voting results are generally divided into two categories: positive votes and negative votes. These two results both have corresponding identifiers, and would be each accompanied by a suggested transaction quantity from a local node. Finally, the local node broadcasts, in the blockchain, the node voting results. When there are malicious nodes, due to a limitation of a transaction quantity upper limit in a block, the malicious node would generally send some relatively low values. In this way, the data volume of transactions in blocks in several continuous rounds would continuously decrease, but the consensus can be reached, albeit with each block containing a relatively small quantity of transactions. The suggested transaction quantity is also increased when casting a positive vote, such that an excessively low transaction quantity can be corrected in a timely manner, thus avoiding that malicious nodes reduce the blockchain transaction processing efficiency, and enhancing the security of the solution.

In some embodiments, the blockchain node would acquire a plurality of voting results generated for a first block proposal by a plurality of blockchain nodes within a first consensus round of the first block proposal, and then generate a transaction quantity limit for a second consensus round according to a suggested transaction quantity in each voting result, where the second consensus round is a next consensus round of the first consensus round. Moreover, when becoming a proposal node, the blockchain node packages blockchain transactions according to the determined transaction quantity limit for the second consensus round into a new block proposal, and broadcasts, in the blockchain, the new block proposal, so as to generate a new block in the blockchain. In this way, the quantity of transactions to be packaged when a proposal is made next time is adjusted according to the suggestion from each node in the consensus process, such that the transactions included in the block proposal can be automatically adjusted according to the execution result and the execution time of the proposal, thus avoiding execution timeout during proposal verification caused by excessive transactions in the block, further preventing a proposal failure due to timeout during proposal verification, and facilitating the improvement of the blockchain operation efficiency.

In some exemplary embodiments of this application, based on the foregoing technical solutions, in the process of generating node voting results for the third block proposal according to the execution result of the third block proposal and the suggested transaction quantity from the local node, the node would determine voting information for the third block proposal according to a matching result between the execution result of the blockchain transactions in the third block proposal and a proposal result in the third block proposal. The node then signs the voting information according to a blockchain key of the local node, so as to obtain a voting signature, and signs the suggested transaction quantity according to the blockchain key of the local node, so as to obtain an information signature. Finally, the nodes generate node voting results for the third block proposal according to the voting information, the voting signature, the suggested transaction quantity, and the information signature.

The blockchain key is a key possessed by a blockchain node, and is configured for signing important information such as voting information and suggested transaction quantity, thereby ensuring the security, the authenticity, and the integrity of the information during transmission and storage, and preventing the information from being tampered with or forged.

The voting signature refers to a result obtained by a local node signing the voting information for the third block proposal according to a blockchain key of the local node. The voting signature is configured for ensuring the authenticity and the integrity of the voting information. The voting information is information (typically in favor or against) determined based on a matching result between an execution result of the blockchain transaction in the third block proposal and a proposal result in the third block proposal. The voting information is configured for conveying the attitude of a node for the third block proposal, and is an important component of the node voting result.

The information signature is a result obtained by a local node signing the suggested transaction quantity, the current block height in the blockchain, and the consensus round number of the third block proposal according to a blockchain key of the local node. The information signature is configured for preventing forged voting results from being sent and to ensure the authenticity and the validity of information such as suggested transaction quantity.

The current block height refers to a positional identifier of a current block in a blockchain, and represents the quantity of blocks from a genesis block to the current block of the blockchain. Adding this information when generating node voting results may be used for determining whether the voting results are issued for a current consensus round, thereby preventing forged voting results from being sent

In some embodiments, in the node voting results, the voting information and the suggested transaction quantity are each signed, such that a node incapable of providing the suggested transaction quantity can still run a consensus based on only the voting information and a corresponding signature, thereby improving the compatibility of the solution.

In some exemplary embodiments of this application, based on the foregoing technical solutions, in the process of signing the suggested transaction quantity according to the blockchain key of the local node, so as to obtain an information signature, the node would acquire a current block height in the blockchain and a consensus round number of a third block proposal, and sign the suggested transaction quantity, the current block height, and the consensus round number according to the blockchain key of the local node, so as to obtain the information signature. When generating the node voting results, the node would generate the node voting results for the third block proposal according to the voting information, the voting signature, the suggested transaction quantity, the current block height, the consensus round number, and the information signature. The consensus round number refers to a round number for voting on and reaching a consensus on different block proposals in the consensus process of a blockchain, which round number is configured for identifying a current round of consensus. Adding this information when generating node voting results facilitates a node determining the timeliness of the voting results, thus avoiding the impact of the sending of forged voting results.

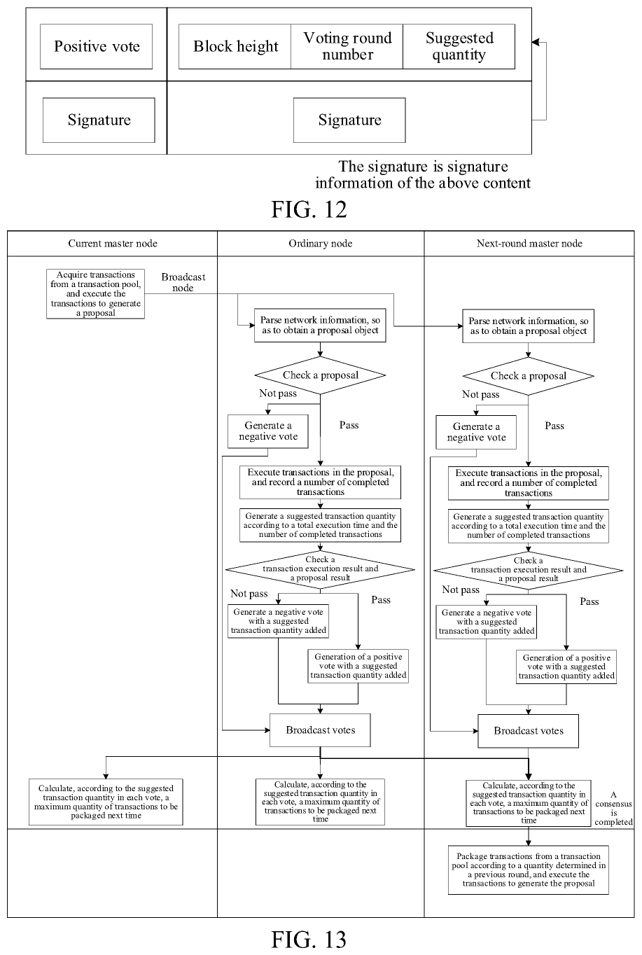

Referring to FIG. 12, FIG. 12 is a schematic diagram showing the structure of node voting results according to some embodiments. As shown in FIG. 12, in some embodiments, a current block height and a consensus round number are further added to each node voting result, which are mainly configured for preventing forged voting results from being sent. Specifically, a malicious node may collect voting results of other nodes in a previous round, and then send the voting results of the other nodes in the previous round in a next round of consensus, thereby causing the other nodes to mistakenly identify the voting results as results sent by an original node in a current round to lead to erroneous confirmation of transaction quantities. The current block height and the consensus round number in each node voting result may be used for a node to determine whether the voting results are sent for the current consensus round, thus avoiding the impact of the sending of forged voting results, and enhancing the security of the solution.

In some exemplary embodiments of this application, based on the foregoing technical solution, in the process of determining a suggested transaction quantity from a local node according to the execution result and the execution time, the node determines a candidate suggested quantity from the local node according to the first proposed transaction quantity, a node capability parameter, and the execution time, where the node capability parameter is determined according to a historical transaction execution result of the local node. The node uses the larger of the candidate suggested quantity and the first proposed transaction quantity as the suggested transaction quantity from the local node if the execution result matches the proposal result in the third block proposal. The node uses the smaller of the candidate suggested quantity and the first proposed transaction quantity as the suggested transaction quantity from the local node if the execution result does not match the proposal result in the third block proposal.

The node capability parameter is a parameter determined according to a historical transaction execution result of a local node, which parameter is configured for determining a candidate suggested quantity from the local node, and may be updated according to suggested transaction quantities from other blockchain nodes. The candidate suggested quantity is a quantity value determined by the local node according to the first proposed transaction quantity, a node capability parameter, and the execution time, which quantity value is configured for determining a suggested transaction quantity from the local node.

In some embodiments, the local node determines the candidate suggested quantity according to the node capability parameter determined according to historical transactions. Specifically, the candidate suggested quantity may be (current quantity* X)/current time, where X is a node capability parameter. The node capability parameter is determined according to a historical transaction execution result of the local node. For example, the node capability parameter is determined according to the execution of historical transactions and a difference between a current quantity and quantities provided by other nodes. After determining the candidate suggested quantity from the local node, the larger of the candidate suggested quantity and the first proposed transaction quantity is selected as the suggested transaction quantity if the execution result matches the proposal result in the third block proposal. Otherwise, the smaller of the candidate suggested quantity and the first proposed transaction quantity is selected as the suggested transaction quantity if the execution result does not match the proposal result in the third block proposal. In some embodiments, the candidate suggested quantity is determined according to the node capability parameter determined by the historical transaction execution result, and then the suggested transaction quantity is selected according to the match between the execution result and the proposal result. Compared with directly determining the suggested transaction quantity according to the computing capability of the local node, the above-mentioned determining approach enables the degree of matching between the determined suggested transaction quantity and the execution result to be higher, thereby facilitating the accuracy of the determined suggested transaction quantity.

In some exemplary embodiments of this application, based on the foregoing technical solutions, the node would further determine a baseline quantity according to suggested transaction quantities from other blockchain nodes in a plurality of voting results generated for the first block proposal by a plurality of blockchain nodes within the first consensus round, and then update the node capability parameter of the local node according to the baseline quantity, a suggested transaction quantity from the local node in the plurality of voting results generated for the first block proposal by the plurality of blockchain nodes within the first consensus round, and a proposal execution time threshold in the blockchain.

The baseline quantity is a quantity value determined according to suggested transaction quantities from other blockchain nodes in a plurality of voting results generated for the first block proposal by the plurality of blockchain nodes within the first consensus round, which quantity value is configured for updating the node capability parameter of the local node. The proposal execution time threshold is a time limit preset in a blockchain, which is configured for limiting a total execution time of all transactions in a block proposal. If the execution time exceeds the threshold, the proposal may fail.

In some embodiments, the blockchain node would adjust the node capability parameter of the local node according to the suggested transaction quantities provided by the other nodes. Specifically, the local node would determine the baseline quantity according to suggested transaction quantities from other blockchain nodes in the plurality of voting results generated for the first block proposal by the plurality of blockchain nodes within the first consensus round. For example, for transactions based on the same quantity (for example, 10000), suggested transaction quantities from other nodes are all 5000, and if the suggested transaction quantity from this node is 4000, 5000 may be used as the baseline quantity. The baseline quantity may be a quantity that appears most frequently among the suggested transaction quantities from the other blockchain nodes, but may be determined in other ways, for example, mean value or median value. Subsequently, the local node would adjust its node capability parameter according to the baseline quantity. For example, the local node may expand a current node capability parameter according to the ratio of the difference between the baseline quantity and the suggested transaction quantity to the proposal execution time threshold. Specifically, in some embodiments, the node capability parameter may be equal to 4000*10*0.8/5000, where 10 is the proposal execution time threshold, i.e., 10 seconds, and 0.8 is a preset adjusted threshold. The process of updating the node capability parameter of the local node is generally performed after the consensus is completed. In some embodiments, the local node would update the node capability parameter of the local node according to the suggested transaction quantities from the other nodes, such that the suggested transaction quantity generated by the local node can be adjusted in a timely manner, thus avoiding that the quantity of transactions packaged in a block is affected due to excessively high or excessively low suggested transaction quantity, and improving the reasonableness of the transaction quantity in the block.

The implementation process of the technical solution of this application will be introduced below with reference to embodiments. Referring to FIG. 13, FIG. 13 is a schematic flowchart showing the overall flow of block proposal processing according to some embodiments. As shown in FIG. 13, a current consensus node would acquire to-be-packaged transactions from a transaction pool, and execute the acquired transactions, thereby generating a block proposal for the current round of consensus. Subsequently, a current master node broadcasts the proposal to other nodes in a blockchain. The other nodes are mainly divided into ordinary nodes and next-round master nodes, but processing procedures of these two types of nodes in the consensus process of the current round are the same. Using the ordinary node as an example, the ordinary node would parse broadcast network information, thereby acquiring a broadcast block proposal. Network information: Information transmitted when nodes communicate with each other in a blockchain network, which information includes data such as block proposals and voting results. The ordinary node may parse the broadcast network information to acquire content such as the broadcast block proposal.

Subsequently, the node will check a proposal object itself. If the check fails, negative votes are directly generated. If the check passes, the node would execute all transactions in the proposal, and record the number of completed transactions. Subsequently, a suggested quantity of transactions is generated according to the total execution time and the number of completed transactions. The node would check a transaction execution result and a proposal result. If the check passes, positive votes would be generated, and if the check fails, negative votes would be generated. At this point, the suggested transaction quantity would be added to both of the votes. Subsequently, the node broadcasts the voting results to the other nodes in the blockchain. Each node in the blockchain would calculate a maximum quantity of transactions to be packaged next time according to the suggested transaction quantities in the votes. After the current round of consensus is completed, the next-round master node would acquire to-be-packaged transactions from a transaction pool according to a quantity determined in a previous round, and execute the acquired transactions, thereby generating a block proposal for a next round of consensus.

Proposal object: i.e., a block proposal, which is an object generated by a master node packaging blockchain transactions, and is used for a consensus between blockchain nodes. The ordinary node would check the proposal object itself, so as to determine whether the proposal object meets a requirement.

Ordinary node: A node other than a master node and a next-round master node in the consensus process of a blockchain. In the consensus process of a current round, the node would receive a block proposal broadcast by the master node, check and execute the proposal, generate and broadcast voting results according to an execution result, and generate a suggested quantity of transactions according to a total execution time and the number of completed transactions.

Number of completed transactions: The number of successfully completed transactions when a node executes blockchain transactions in a block proposal. The node would generate the suggested quantity of transactions according to the quantity and a total execution time.

Although various operations of the method of this application are described in a order in the drawing, this does not require or imply that the operations may be executed in the order, or all the operations shown may be executed to achieve the expected result. Additionally or In some embodiments, some operations may be omitted, a plurality of operations may be combined into one operation for execution, and one operation may be decomposed into a plurality of operations for execution, and the like.

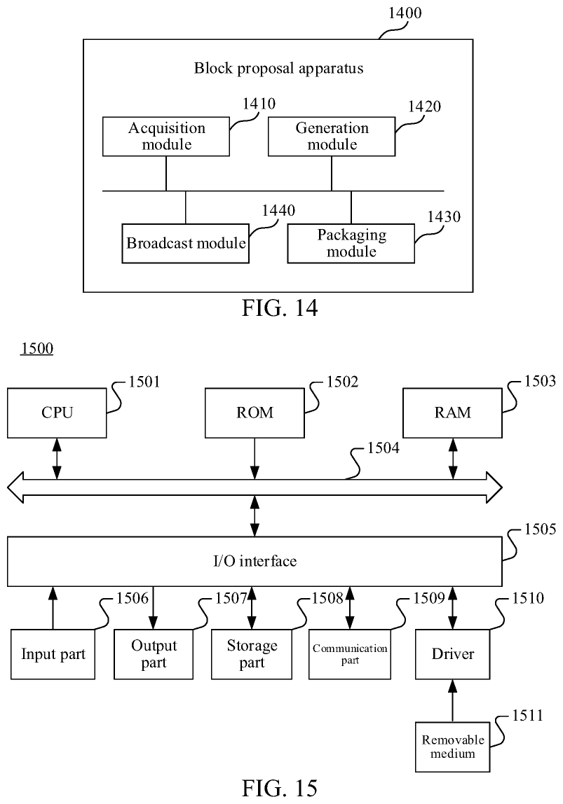

An apparatus embodiment of this application will be introduced below, which may be configured to execute the block proposal method in the foregoing embodiments of this application. FIG. 14 schematically shows a block diagram of the composition of a block proposal apparatus according to some embodiments. As shown in FIG. 14, the block proposal apparatus 1400 may mainly include:

an acquisition module 1410, configured to acquire a plurality of voting results generated for a first block proposal by a plurality of blockchain nodes within a first consensus round in a blockchain, where each voting result includes a suggested transaction quantity, and the suggested transaction quantity is determined according to a first proposed transaction quantity in the first block proposal and an execution time for the blockchain nodes generating the voting results to execute the first block proposal;

a generation module 1420, configured to generate a transaction quantity limit for a second consensus round according to the suggested transaction quantity included in each of the plurality of voting results, the second consensus round being a next consensus round of the first consensus round;

a packaging module 1430, configured to package blockchain transactions in a local transaction pool according to the transaction quantity limit to generate a second block proposal for a plurality of blockchain nodes within the second consensus round in the blockchain to vote; and

a broadcast module 1440, configured to broadcast, in the blockchain, the second block proposal.

In some embodiments, based on the foregoing technical solutions, the generation module 1420 is configured to: determine a proposal consensus result for the first block proposal according to the plurality of voting results generated for the first block proposal by the plurality of blockchain nodes within the first consensus round; acquire, as candidate voting results, voting results corresponding to the proposal consensus result according to the proposal consensus result from the plurality of voting results generated for the first block proposal by the plurality of blockchain nodes within the first consensus round; and generate a transaction quantity limit for a second consensus round according to the suggested transaction quantity in each candidate voting result, where the second consensus round is a next consensus round of the first consensus round.

In some embodiments, based on the foregoing technical solutions, the generation module 1420 is configured to: use, as the candidate voting results, if the proposal consensus result indicates that the proposal succeeds, voting results indicating positive votes among the plurality of voting results generated for the first block proposal by the plurality of blockchain nodes within the first consensus round; and use, as the candidate voting results, if the proposal consensus result indicates that the proposal fails, voting results indicating negative votes among the plurality of voting results generated for the first block proposal by the plurality of blockchain nodes within the first consensus round.

In some embodiments, based on the foregoing technical solutions, the generation module 1420 is configured to: acquire a first proposed transaction quantity in a first block proposal if a proposal consensus result indicates that the proposal succeeds; use the first proposed transaction quantity as the transaction quantity limit for a second consensus round if the first proposed transaction quantity is greater than or equal to the suggested transaction quantity in each candidate voting result; and generate a transaction quantity limit for the second consensus round according to a mean value of the first proposed transaction quantity and the selected suggested transaction quantity if the first proposed transaction quantity is less than the suggested transaction quantity in each candidate voting result.

In some embodiments, based on the foregoing technical solutions, the candidate voting result includes the plurality of voting results generated for the first block proposal by the plurality of blockchain nodes within the first consensus round. The generation module 1420 is configured to: acquire a block transaction quantity threshold for the blockchain if the first proposed transaction quantity is less than the suggested transaction quantity in each candidate voting result; delete the voting results from the candidate voting results if the suggested transaction quantity in any voting result among the candidate voting results is greater than the block transaction quantity threshold; and generate a transaction quantity limit for the second consensus round according to the mean value of the first proposed transaction quantity and the suggested transaction quantity in each voting result among the candidate voting results.

In some embodiments, based on the foregoing technical solutions, the generation module 1420 is configured to: acquire the suggested transaction quantity in each candidate voting result if the proposal consensus result indicates that the proposal fails; and determine the transaction quantity limit for the second consensus round according to a sum of the suggested transaction quantities in the candidate voting results and the quantity of the candidate voting results.

In some embodiments, based on the foregoing technical solutions, the broadcast module 1440 is further configured to: acquire a third block proposal generated by the master node; execute the blockchain transactions in the third block proposal, so as to obtain an execution result and an execution time of the third block proposal; and determine a suggested transaction quantity from the local node according to the execution result and the execution time; generate node voting results for the third block proposal according to the execution result of the third block proposal and the suggested transaction quantity from the local node; and broadcast, in the blockchain, the node voting results.

In some embodiments, based on the foregoing technical solutions, the broadcast module 1440 is configured to: determine voting information for the third block proposal according to a matching result between the execution result of the blockchain transactions in the third block proposal and a proposal result in the third block proposal; sign the voting information according to a blockchain key of the local node, so as to obtain a voting signature; sign the suggested transaction quantity according to the blockchain key of the local node, so as to obtain an information signature; and generate node voting results for the third block proposal according to the voting information, the voting signature, the suggested transaction quantity, and the information signature.

In some embodiments, based on the foregoing technical solutions, the broadcast module 1440 is configured to: acquire a current block height in the blockchain and a consensus round number of a third block proposal; sign the suggested transaction quantity, the current block height, and the consensus round number according to the blockchain key of the local node, so as to obtain the information signature; and generate node voting results for the third block proposal according to the voting information, the voting signature, the suggested transaction quantity, the current block height, the consensus round number, and the information signature.

In some embodiments, based on the foregoing technical solutions, the broadcast module 1440 is configured to: determine a candidate suggested quantity from the local node according to the first proposed transaction quantity, a node capability parameter, and the execution time, where the node capability parameter is determined according to a historical transaction execution result of the local node; use the larger of the candidate suggested quantity and the first proposed transaction quantity as the suggested transaction quantity from the local node if the execution result matches the proposal result in the third block proposal; and use the smaller of the candidate suggested quantity and the first proposed transaction quantity as the suggested transaction quantity from the local node if the execution result does not match the proposal result in the third block proposal.

In some embodiments, based on the foregoing technical solutions, the broadcast module 1440 is configured to: determine a baseline quantity according to suggested transaction quantities from other blockchain nodes in a plurality of voting results generated for the first block proposal by a plurality of blockchain nodes within the first consensus round, and update the node capability parameter of the local node according to the baseline quantity, a suggested transaction quantity from the local node in the plurality of voting results generated for the first block proposal by the plurality of blockchain nodes within the first consensus round, and a proposal execution time threshold in the blockchain.

The apparatus provided in the foregoing embodiment and the method provided in the foregoing embodiment belong to the same concept, ways in which each module executes operations have been described in detail in the method embodiments. Details are not described herein again.

According to the block proposal method and apparatus, and the electronic device, the computer-readable medium, and the computer program product that are provided in this application, a blockchain node in a blockchain acquires a plurality of voting results generated for a first block proposal by a plurality of blockchain nodes within a first consensus round in a blockchain, where each voting result includes a suggested transaction quantity, and the suggested transaction quantity is determined according to a first proposed transaction quantity in the first block proposal and an execution time for the blockchain nodes generating the voting results to execute the first block proposal. A transaction quantity limit for a second consensus round is then generated according to the suggested transaction quantity included in each of the plurality of voting results, where the second consensus round is a next consensus round of the first consensus round. Next, the blockchain transactions in the local transaction pool are packaged according to the transaction quantity limit, so as to generate a second block proposal. Finally, the second block proposal is broadcast in the blockchain. The second block proposal is configured for instructing a plurality of blockchain nodes within a second consensus round in the blockchain to vote. In this way, the quantity of transactions to be packaged in a next proposal can be adjusted according to a suggestion from each node in the consensus process, and transactions included in a block proposal are automatically adjusted, thus avoiding execution timeout during proposal verification caused by excessive transactions, preventing a proposal failure, and improving the blockchain operation efficiency.

Further, the blockchain node determines a proposal consensus result for the first block proposal according to the plurality of voting results generated for the first block proposal by the plurality of blockchain nodes within the first consensus round; acquires, as candidate voting results, voting results corresponding to the proposal consensus result according to the proposal consensus result from the plurality of voting results generated for the first block proposal by the plurality of blockchain nodes within the first consensus round; and then generates a transaction quantity limit for a second consensus round according to the suggested transaction quantity in each candidate voting result. By doing so, the degree of impact of correct voting results among determining factors for the transaction quantity limit for the second consensus round is higher, thereby improving the accuracy of the determined transaction quantity limit.

The blockchain node uses, as the candidate voting results, when the proposal consensus result indicates that the proposal succeeds, voting results indicating positive votes among the plurality of voting results generated for the first block proposal by the plurality of blockchain nodes within the first consensus round; and uses, as the candidate voting results, when the proposal consensus result indicates that the proposal fails, voting results indicating negative votes among the plurality of voting results generated for the first block proposal by the plurality of blockchain nodes within the first consensus round. This can avoid that the impact of the suggested quantity provided by nodes that misjudge consensus nodes on the specified quantity, thereby reducing a probability that the process of determining a transaction quantity is affected by malicious data, and enhancing the security of the blockchain system.

The blockchain node acquires a first proposed transaction quantity in the first block proposal if the proposal consensus result indicates that the proposal succeeds, and uses the first proposed transaction quantity as the transaction quantity limit for the second consensus round if the first proposed transaction quantity is greater than or equal to the suggested transaction quantity in each candidate voting result. In this way, the slave node directly uses the first proposed transaction quantity as a next round transaction quantity limit when approving the quantity of transactions packaged by the master node.

The blockchain node generates the transaction quantity limit for the second consensus round according to a mean value of the first proposed transaction quantity and the selected suggested transaction quantity if the first proposed transaction quantity is less than the suggested transaction quantity in each candidate voting result. This can increase a transaction quantity limit for a block proposal in a timely manner when the master node packages a relatively small quantity of transactions, thus avoiding the waste of processing resources in the consensus process due to too few transactions in a block, and improving the resource utilization of the solution.

The candidate voting result includes the plurality of voting results generated for the first block proposal by the plurality of blockchain nodes within the first consensus round. The blockchain node acquires a block transaction quantity threshold for the blockchain if the first proposed transaction quantity is less than the suggested transaction quantity in each candidate voting result, deletes the voting results from the candidate voting results if the suggested transaction quantity in any voting result among the candidate voting results is greater than the block transaction quantity threshold, and then generates a transaction quantity limit for the second consensus round according to the mean value of the first proposed transaction quantity and the suggested transaction quantity in each voting result among the candidate voting results. This can avoid a consensus failure caused by proposal execution timeout due to excessive transactions in a block proposal, thereby improving the stability of the solution.

The blockchain node acquires the suggested transaction quantity in each candidate voting result if the proposal consensus result indicates that the proposal fails, and determines the transaction quantity limit for the second consensus round according to a sum of the suggested transaction quantities in the candidate voting results and the quantity of the candidate voting results. This can reduce an excessively high transaction quantity or the excessively long execution time in a timely manner when a proposal fails by determining a limit only according to the suggested transaction quantity in the candidate voting results indicating failure, thus avoiding that the subsequent consensus process fails again, and improving the consensus success rate.

The blockchain node broadcasts the second block proposal in the blockchain, and then acquires a third block proposal generated by the master node, executes the blockchain transactions in the third block proposal, so as to obtain an execution result and an execution time of the third block proposal, and determines a suggested transaction quantity from the local node according to the execution result and the execution time; generates node voting results for the third block proposal according to the execution result of the third block proposal and the suggested transaction quantity from the local node; and broadcasts, in the blockchain, the node voting results. By increasing the suggested transaction quantity when casting a positive vote, an excessively low transaction quantity can be corrected in a timely manner, thus avoiding that malicious nodes reduce the blockchain transaction processing efficiency, and enhancing the security of the solution.

The blockchain node determines voting information for the third block proposal according to a matching result between the execution result of the blockchain transactions in the third block proposal and a proposal result in the third block proposal, signs the voting information according to a blockchain key of the local node, so as to obtain a voting signature, signs the suggested transaction quantity according to the blockchain key of the local node, so as to obtain an information signature, and generates node voting results for the third block proposal according to the voting information, the voting signature, the suggested transaction quantity, and the information signature. In the node voting results, the voting information and the suggested transaction quantity are each signed, such that a node incapable of providing the suggested transaction quantity can still run a consensus based on the voting information and a corresponding signature, thereby improving the compatibility of the solution.

The blockchain node acquires a current block height in the blockchain and a consensus round number of a third block proposal, signs the suggested transaction quantity, the current block height, and the consensus round number according to the blockchain key of the local node, so as to obtain the information signature, and generates node voting results for the third block proposal according to the voting information, the voting signature, the suggested transaction quantity, the current block height, the consensus round number, and the information signature. The current block height and the consensus round number are added to each node voting result, thereby preventing forged voting results from being sent, avoiding erroneous confirmation of transaction quantities by the node due to the impact of the forged voting results, and enhancing the security of the solution.

The blockchain node determines a candidate suggested quantity from the local node according to the first proposed transaction quantity, a node capability parameter, and the execution time, where the node capability parameter is determined according to a historical transaction execution result of the local node, and uses the larger of the candidate suggested quantity and the first proposed transaction quantity as the suggested transaction quantity from the local node if the execution result matches the proposal result in the third block proposal. Compared with directly determining the suggested transaction quantity according to the computing capability of the local node, this approach enables the degree of matching between the determined suggested transaction quantity and the execution result to be higher, thereby improving the accuracy of the determined suggested transaction quantity.

The blockchain node uses the smaller of the candidate suggested quantity and the first proposed transaction quantity as the suggested transaction quantity from the local node if the execution result does not match the proposal result in the third block proposal. This further refines the manner of determining the suggested transaction quantity according to the execution result, such that the suggested transaction quantity is more aligned with actual execution.

The blockchain node determines a baseline quantity according to suggested transaction quantities from other blockchain nodes in a plurality of voting results generated for the first block proposal by a plurality of blockchain nodes within the first consensus round, and updates the node capability parameter of the local node according to the baseline quantity, a suggested transaction quantity from the local node in the plurality of voting results generated for the first block proposal by the plurality of blockchain nodes within the first consensus round, and a proposal execution time threshold in the blockchain. By updating the node capability parameter of the local node according to the suggested transaction quantities from the other nodes, the suggested transaction quantity generated by the local node can be adjusted in a timely manner, thus avoiding that the quantity of transactions packaged in a block is affected due to excessively high or excessively low suggested transaction quantity, and improving the reasonableness of the transaction quantity in the block.

FIG. 15 shows a schematic structural diagram of a computer system of an electronic device applicable to implementing some embodiments.

The computer system 1500 of the electronic device shown in FIG. 15 is merely an example, and does not constitute any limitation on the function and scope of use of the embodiments of this application.

As shown in FIG. 15, the computer system 1500 includes a central processing unit (CPU) 1501, which may execute various appropriate actions and processing according to a program stored in a read-only memory (ROM) 1502 or a program loaded from a storage part 1508 into a random access memory (RAM) 1503. The RAM 1503 further has various programs and data for system operation stored therein. The CPU 1501, the ROM 1502, and the RAM 1503 are connected to each other through a bus 1504. An input/output (I/O) interface 1505 is also connected to the bus 1504.

The following components are connected to the I/O interface 1505: an input part 1506, including a keyboard, a mouse, and the like; an output part 1507, including such as a cathode ray tube (CRT), a liquid crystal display (LCD), and a speaker; a storage portion 1508, including a hard disk and the like; a communications part 1509, including a network interface card such as a local area network (LAN) card or a modem. The communication part 1509 executes communication processing by using a network such as the Internet. A drive 1510 is also connected to the I/O interface 1505 as required. A removable medium 1511 such as a magnetic disk, an optical disk, a magneto-optical disk, or a semiconductor memory is installed on the drive 1510 as required, so that a computer program read from the removable medium is installed into the storage part 1508 as required.

Particularly, according to the embodiments of this application, the process described in each method flowchart may be implemented as a computer software program. For example, some embodiments includes a computer program product, which includes a computer program carried on a computer-readable storage medium, where the computer program includes a program code configured for executing the methods shown in the flowcharts. In such embodiments, the computer program may be downloaded and installed from a network through the communication part 1509, or installed from the removable medium 1511. When the computer program is executed by the central processing unit (CPU) 1501, various functions defined in the system of this application are executed.

The computer-readable medium described in the embodiments of this application may be a computer-readable signal medium, a computer-readable storage medium, or any combination thereof. The computer-readable storage medium may be, for example (but is not limited to) an electric, magnetic, optical, electromagnetic, infrared, or semiconductor system, apparatus, or device, or any combination thereof. The more examples of the computer-readable storage medium may include but are not limited to electrical connections with one or more conducting wires, a portable computer disc, a hard disk, a random access memory (RAM), a read-only memory (ROM), an erasable programmable read-only memory (EPROM), a flash memory, an optical fiber, a portable compact disc read-only memory (CD-ROM), an optical storage device, a magnetic storage device, or any suitable combination thereof. In this application, the computer-readable storage medium may be any tangible medium including or storing a program. The program may be used by or in combination with an instruction execution system, apparatus, or device. In this application, the computer-readable signal medium may include a data signal propagated in a baseband or as part of a carrier, in which a computer-readable program code is carried. Such propagated data signal may be in various forms, including, but not limited to, an electromagnetic signal, an optical signal or any suitable combination thereof. The computer-readable signal medium may further be any computer-readable medium other than the computer-readable storage medium. The computer-readable medium may send, propagate, or transmit a program used by or in combination with the instruction execution system, apparatus, or device. The program code included on the computer-readable medium may be transmitted using any appropriate medium, including, but not limited to: a wireless medium, a wired medium, and the like, or any suitable combination thereof.

The flowcharts and block diagrams in the drawing illustrate possible system architectures, functions and operations that may be implemented by a system, a method, and a computer program product according to various embodiments of this application. In this regard, each block in the flowchart or the block diagram may represent a module, a program segment, or a part of code. The module, the program segment, or the part of the code includes one or more executable instructions for implementing a specified logical function. In some alternative implementations, functions annotated in the blocks may also be executed in a different order from those annotated in the drawing. For example, two boxes shown in succession may actually be executed basically in parallel, and sometimes the two boxes may be executed in a reverse order. This depends on the functions involved. Each box of the block diagrams or the flowcharts and combinations of boxes in the block diagrams or the flowcharts may be implemented by a dedicated hardware-based system that executes specified functions or operations, or may be implemented by a combination of dedicated hardware and a computer instruction.

Although a plurality of modules or units of a device configured to execute actions are mentioned in the foregoing detailed description, such division is not mandatory. In fact, according to the implementations of this application, the features and functions of the two or more modules or units described above may be embodied in one module or unit. On the contrary, the features and functions of one module or unit described above may further be divided to be embodied by a plurality of modules or units.

Through the foregoing descriptions of the implementations, a person skilled in the art may readily understand that the exemplary implementations described herein may be implemented by software, or may be implemented by combining software with necessary hardware. Therefore, the technical solutions according to the implementations of this application may be embodied in a form of a software product. The software product may be stored in a non-volatile storage medium (which may be a CD-ROM, a USB flash drive, a removable hard disk, or the like) or on the network, including several instructions for enabling a computing device (which may be a personal computer, a server, a touch terminal, a network device, or the like) to execute the method according to the implementations of this application.

A person skilled in the art can easily figure out other implementations of this application after considering the description and practicing the disclosure that is disclosed herein. This application is intended to cover any variations, usages, or adaptive changes of this application. These variations, usages, or adaptive changes follow the general principles of this application and include common general knowledge or common technical means in the technical field not disclosed in this application.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this description provided that no conflict exists.

The foregoing embodiments describe merely several implementations of this application and the description is and detailed, but they are not to be understood as a limitation to the patent scope of the disclosure. For those of ordinary skill in the art, several transformations and improvements may further be made without departing from the idea of this application. These transformations and improvements fall within the scope of protection of this application. Therefore, the protection scope of this application is subject to the claims.

What is claimed is:

1. A block proposal method, performed by blockchain nodes in a blockchain, and the method comprising:
acquiring a plurality of voting results generated for a first block proposal by a plurality of blockchain nodes within a first consensus round in the blockchain,
each of the plurality of voting results comprising a suggested transaction quantity that is determined based on a first proposed transaction quantity in the first block proposal and an execution time for executing the first block proposal;
generating a transaction quantity limit for a second consensus round based on the suggested transaction quantity in each of the plurality of voting results, the second consensus round being a next consensus round of the first consensus round;
packaging blockchain transactions from a local transaction pool based on the transaction quantity limit;
generating a second block proposal for the plurality of blockchain nodes within the second consensus round in the blockchain to vote; and
broadcasting the second block proposal in the blockchain.

2. The block proposal method according to claim 1, wherein the generating the transaction quantity limit comprises:
determining a proposal consensus result for the first block proposal based on the plurality of voting results;
acquiring, as candidate voting results, voting results corresponding to the proposal consensus result from the plurality of voting results; and
generating the transaction quantity limit for the second consensus round based on the suggested transaction quantity in each of the candidate voting results.

3. The block proposal method according to claim 2, wherein the acquiring the candidate voting results comprises:
based on the proposal consensus result indicating that the proposal succeeds, using, as the candidate voting results, voting results indicating positive votes among the plurality of voting results; and
based on the proposal consensus result indicating that the proposal fails, using, as the candidate voting results, voting results indicating negative votes among the plurality of voting results.

4. The block proposal method according to claim 2, wherein the generating the transaction quantity limit comprises:
based on the proposal consensus result indicating that the proposal succeeds, acquiring the first proposed transaction quantity in the first block proposal; and
based on the first proposed transaction quantity being greater than or equal to the suggested transaction quantity in each of the candidate voting results, using the first proposed transaction quantity as the transaction quantity limit for the second consensus round.

5. The block proposal method according to claim 4, wherein the generating the transaction quantity limit further comprises:
based on the first proposed transaction quantity being less than the suggested transaction quantity in each of the candidate voting results, generating the transaction quantity limit for the second consensus round based on a mean value of the first proposed transaction quantity and the suggested transaction quantity in each of the candidate voting results.

6. The block proposal method according to claim 5, wherein the candidate voting results comprise the plurality of voting results; and wherein the generating the transaction quantity limit further comprises:
acquiring a block transaction quantity threshold for the blockchain;
deleting, from the candidate voting results, each voting result having a suggested transaction quantity greater than the block transaction quantity threshold; and
generating the transaction quantity limit for the second consensus round based on the mean value of the first proposed transaction quantity and the suggested transaction quantity in each remaining voting result among the candidate voting results.

7. The block proposal method according to claim 2, wherein the generating the transaction quantity limit comprises:
based on the proposal consensus result indicating that the proposal fails, acquiring the suggested transaction quantity in each of the candidate voting results; and
determining the transaction quantity limit for the second consensus round based on a sum of the suggested transaction quantities in the candidate voting results and a quantity of the candidate voting results.

8. The block proposal method according to claim 1, wherein after the broadcasting the second block proposal in the blockchain, the method further comprises:
acquiring a third block proposal generated by a master node;
executing the blockchain transactions in the third block proposal to obtain an execution result and an execution time of the third block proposal;
determining a suggested transaction quantity from a local node based on the execution result and the execution time;
generating node voting results for the third block proposal based on the execution result of the third block proposal and the suggested transaction quantity from the local node; and
broadcasting the node voting results in the blockchain.

9. The block proposal method according to claim 8, wherein the generating the node voting results comprises:
determining voting information for the third block proposal based on a matching result between the execution result of the blockchain transactions in the third block proposal and a proposal result in the third block proposal;
signing the voting information using a blockchain key of the local node to obtain a voting signature;
signing the suggested transaction quantity using the blockchain key of the local node to obtain an information signature; and
generating the node voting results for the third block proposal based on the voting information, the voting signature, the suggested transaction quantity, and the information signature.

10. The block proposal method according to claim 9, wherein the signing the suggested transaction quantity to obtain the information signature comprises:
acquiring a current block height in the blockchain and a consensus round number of the third block proposal; and
signing the suggested transaction quantity, the current block height, and the consensus round number using the blockchain key of the local node to obtain the information signature; and
wherein the generating the node voting results further comprises:
generating the node voting results for the third block proposal based on the voting information, the voting signature, the suggested transaction quantity, the current block height, the consensus round number, and the information signature.

11. The block proposal method according to claim 8, wherein the determining the suggested transaction quantity comprises:
determining a candidate suggested quantity from the local node based on the first proposed transaction quantity, a node capability parameter, and the execution time, the node capability parameter being determined based on a historical transaction execution result of the local node; and
based on the execution result matching a proposal result in the third block proposal, using the larger of the candidate suggested quantity and the first proposed transaction quantity as the suggested transaction quantity from the local node.

12. The block proposal method according to claim 11, wherein the determining the suggested transaction quantity further comprises:
based on the execution result not matching the proposal result in the third block proposal, using the smaller of the candidate suggested quantity and the first proposed transaction quantity as the suggested transaction quantity from the local node.

13. The block proposal method according to claim 11, further comprising:
determining a baseline quantity based on suggested transaction quantities from other blockchain nodes in the plurality of voting results; and
updating the node capability parameter of the local node based on the baseline quantity, the suggested transaction quantity from the local node in the plurality of voting results, and a proposal execution time threshold in the blockchain.

14. A block proposal apparatus, comprising:
at least one memory configured to store program code; and
at least one processor configured to read the program code and operate as instructed by the program code, the program code comprising:
acquiring code configured to cause at least one of the at least one processor to acquire a plurality of voting results generated for a first block proposal by a plurality of blockchain nodes within a first consensus round in a blockchain,
each of the plurality of voting results comprising a suggested transaction quantity that is determined based on a first proposed transaction quantity in the first block proposal and an execution time for executing the first block proposal;
generating code configured to cause at least one of the at least one processor to generate a transaction quantity limit for a second consensus round based on the suggested transaction quantity in each of the plurality of voting results, the second consensus round being a next consensus round of the first consensus round;
packaging code configured to cause at least one of the at least one processor to package blockchain transactions from a local transaction pool based on the transaction quantity limit;
proposal code configured to cause at least one of the at least one processor to generate a second block proposal for the plurality of blockchain nodes within the second consensus round in the blockchain to vote; and
broadcasting code configured to cause at least one of the at least one processor to broadcast the second block proposal in the blockchain.

15. The apparatus according to claim 14, wherein the generating code is further configured to cause at least one of the at least one processor to:
determine a proposal consensus result for the first block proposal based on the plurality of voting results;
acquire, as candidate voting results, voting results corresponding to the proposal consensus result from the plurality of voting results; and
generate the transaction quantity limit for the second consensus round based on the suggested transaction quantity in each of the candidate voting results.

16. The apparatus according to claim 15, wherein the generating code is further configured to cause at least one of the at least one processor to:
based on the proposal consensus result indicating that the proposal succeeds, use, as the candidate voting results, voting results indicating positive votes among the plurality of voting results; and
based on the proposal consensus result indicating that the proposal fails, use, as the candidate voting results, voting results indicating negative votes among the plurality of voting results.

17. The apparatus according to claim 15, wherein the generating code is further configured to cause at least one of the at least one processor to:
based on the proposal consensus result indicating that the proposal succeeds, acquire the first proposed transaction quantity in the first block proposal; and
based on the first proposed transaction quantity being greater than or equal to the suggested transaction quantity in each of the candidate voting results, use the first proposed transaction quantity as the transaction quantity limit for the second consensus round.

18. The apparatus according to claim 17, wherein the generating code is further configured to cause at least one of the at least one processor to:
based on the first proposed transaction quantity being less than the suggested transaction quantity in each of the candidate voting results, generate the transaction quantity limit for the second consensus round based on a mean value of the first proposed transaction quantity and the suggested transaction quantity in each of the candidate voting results.

19. The apparatus according to claim 18, wherein the candidate voting results comprise the plurality of voting results; and wherein the generating code is further configured to cause at least one of the at least one processor to:
acquire a block transaction quantity threshold for the blockchain;
delete, from the candidate voting results, each voting result having a suggested transaction quantity greater than the block transaction quantity threshold; and
generate the transaction quantity limit for the second consensus round based on the mean value of the first proposed transaction quantity and the suggested transaction quantity in each remaining voting result among the candidate voting results.

20. A non-transitory computer-readable storage medium, storing computer code which, when executed by at least one processor, causes the at least one processor to at least:
acquire a plurality of voting results generated for a first block proposal by a plurality of blockchain nodes within a first consensus round in a blockchain,
each of the plurality of voting results comprising a suggested transaction quantity that is determined based on a first proposed transaction quantity in the first block proposal and an execution time for executing the first block proposal;
generate a transaction quantity limit for a second consensus round based on the suggested transaction quantity in each of the plurality of voting results, the second consensus round being a next consensus round of the first consensus round;
package blockchain transactions from a local transaction pool based on the transaction quantity limit;
generate a second block proposal for the plurality of blockchain nodes within the second consensus round in the blockchain to vote; and
broadcast the second block proposal in the blockchain.
